(19) United States
(12) Patent Application Publication
(10) Pub. No.: US 2017/0193372 A1
(43) Pub. Date: Jul. 6, 2017

(54) Health Management Using Distances for Segmented Time Series

(71) Applicant: The Boeing Company, Chicago, IL (US)

(72) Inventor: James Schimert, Seabeck, WA (US)

(21) Appl. No.: 14/989,204

(22) Filed: Jan. 6, 2016

(51) Int. Cl. G06N 5/04; G06N 99/00; G06Q 10/00

(52) U.S. Cl. CPC G06N 5/04; G06Q 10/20; G06N 99/005

(57) ABSTRACT

A method, apparatus, and system for evaluating health of a component of a vehicle. Time series data generated during operation of the vehicle is received by a computer system. The computer system transforms the time series data into a plurality of segments based on a selected state for the vehicle that is of interest. The computer system builds a prognostic distance matrix based on pairings formed using the plurality of segments. The prognostic distance matrix comprises distances that measure deviation of the component from nominal performance for the selected state. The computer system generates a digital prognosis for the component of the vehicle based on the prognostic distance matrix. The digital prognosis predicts whether a maintenance operation should be performed with respect to the component. The distances may be used to diagnose what maintenance operation should be performed.

### BACKGROUND INFORMATION

1. Field

The present disclosure relates generally to managing the health of a complex system, such as an aircraft. More particularly, the present disclosure relates to a method and apparatus for evaluating the health of a component of a complex system using distances computed based on segmented time series.

2. Background

Managing the health of a complex system may include managing the health of various components that make up that complex system. This type of health management may include, for example, evaluating the performance of a component in the complex system. Evaluating the performance of a component may include, but is not limited to, acquiring data related to the performance of the component, transforming the data, analyzing the data, forming a diagnosis based on the data, making predictions based on the data, other suitable actions, or some combination thereof.

Machine learning algorithms are increasingly being used to assess the health of complex systems. Machine learning algorithms can learn from and make predictions on data based on supervised learning, unsupervised learning, reinforcement learning, other types of learning, or a combination thereof. Typically, machine learning algorithms require that input data be received in a matrix form.

An aircraft is an example of a complex system. Data captured on an aircraft over time may be high volume time series data that includes data generated over different lengths of time, different sampling frequencies, or both. Using this type of data with machine learning algorithms, data mining algorithms, and other types of algorithms may be more challenging and time-consuming than desired. For example, putting this type of data into a matrix form for input into a machine learning algorithm may be more difficult than desired without loss of information. In particular, this type of data may pose challenges when using machine learning algorithms for prognostic applications, such as predicting health-related events.

For example, the data generated over multiple flights of an aircraft may vary in length based on the different durations of the flights. In some cases, the data may be at different sampling frequencies. Further, the data generated on an aircraft may include many different time series.

Some currently available methods for evaluating systems using time series are more cumbersome and time-consuming than desired, or are difficult to interpret. For example, subject matter experts can help identify features in each time series to reduce the volume of data that is analyzed. However, in some cases, subject matter experts may not be readily available. Thus, the analysis process may be more time-consuming than desired. Further, the features identified by different subject matter experts may vary by expert. Therefore, it would be desirable to have a method and apparatus that take into account at least some of the issues discussed above, as well as other possible issues.

### SUMMARY

In one illustrative embodiment, a method for evaluating a component of a vehicle is provided. Time series data generated during operation of the vehicle is received by a computer system. The computer system transforms the time series data into a plurality of segments based on a selected state for the vehicle that is of interest. The computer system builds a prognostic distance matrix based on pairings formed using the plurality of segments. The prognostic distance matrix comprises distances that measure deviation of the component from nominal performance for the selected state. The computer system generates a digital prognosis for the component of the vehicle based on the prognostic distance matrix. The digital prognosis predicts whether a maintenance operation should be performed with respect to the component.

In another illustrative embodiment, an apparatus comprises a segment generator module, a distance generator module, and a health manager module, which are all implemented in a computer system. The segment generator module receives time series data generated during operation of a vehicle and transforms the time series data into a plurality of segments based on a selected state for the vehicle that is of interest. The distance generator module builds a prognostic distance matrix based on pairings formed using the plurality of segments. The prognostic distance matrix comprises distances that measure deviation of a component from nominal performance for the selected state. A health manager module generates a digital prognosis for the component of the vehicle based on the prognostic distance matrix. The digital prognosis predicts whether a maintenance operation should be performed with respect to the component. The distances may be used to diagnose what maintenance operation should be performed.

In yet another illustrative embodiment, a health management system comprises a segment generator module, a distance generator module, and a health manager module, which are all implemented in a computer system. The segment generator module receives time series data generated during operation of an aircraft and transforms the time series data into a plurality of segments based on a selected state for the aircraft that is of interest. The distance generator module builds a prognostic distance matrix based on pairings formed using the plurality of segments. The prognostic distance matrix comprises distances that measure deviation of the component from nominal performance for the selected state. A health manager module generates a digital prognosis for the component of the aircraft based on the prognostic distance matrix. The digital prognosis predicts whether a maintenance operation should be performed with respect to the component. The distances may be used to diagnose what maintenance operation should be performed.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a health management system in the form of a block diagram in accordance with an illustrative embodiment;

FIG. 3 is an illustration of a set of time series in accordance with an illustrative embodiment;

FIG. 4 is an illustration of a graph of pairings in accordance with an illustrative embodiment;

FIGS. 5A and 5B are illustrations of a segment-segment pairing that is healthy and a segment pair that is not healthy in accordance with an illustrative embodiment;

FIG. 6 is an illustration of a plot of distances over time in accordance with an illustrative embodiment;

FIG. 7 is an illustration of a shapelet and a segment in accordance with an illustrative embodiment;

FIG. 8 is an illustration of a prognostic distance matrix for segment-nominal pairings in accordance with an illustrative embodiment;

FIG. 9 is an illustration of a prognostic distance matrix for segment-segment pairings in accordance with an illustrative embodiment;

FIG. 10 is an illustration of a prognostic distance matrix for shapelet-segment pairings in accordance with an illustrative embodiment;

FIG. 11 is an illustration of a ranking of distances in accordance with an illustrative embodiment;

FIG. 12 is an illustration of digital prognoses in accordance with an illustrative embodiment;

FIG. 13 is an illustration of a process for evaluating a component of a vehicle in the form of a flowchart in accordance with an illustrative embodiment;

FIG. 14 is an illustration of a process for evaluating a component of an aircraft in the form of a flowchart in accordance with an illustrative embodiment;

FIG. 15 is an illustration of a process for computing distances in the form of a flowchart in accordance with an illustrative embodiment;

FIG. 16 is an illustration of a data processing system in the form of a block diagram in accordance with an illustrative embodiment;

FIG. 17 is an illustration of an aircraft manufacturing and service method in the form of a block diagram in accordance with an illustrative embodiment; and

FIG. 18 is an illustration of an aircraft in the form of a block diagram in accordance with an illustrative embodiment.

### DETAILED DESCRIPTION

The illustrative embodiments recognize and take into account different considerations. For example, the illustrative embodiments recognize and take into account that it may be desirable to have a computer-based system that is capable of evaluating the health of a component in a complex system using time series data. In particular, the illustrative embodiments recognize and take into account that it may be desirable to have a method and apparatus for evaluating multiple time series collected during the operation of a complex system, such as an aircraft, to identify prognostic indicators with respect to the health of one or more components in the complex system. A component of a complex system may be a part, a subsystem, an assembly, a sub-assembly, or some other portion of the complex system.

As one illustrative example, an aircraft collects sensor data in the form of time series during flight. In some cases, data measurements may be collected about once per second during flight. This sensor data may be used to assess the health of a subsystem of the aircraft but may be high volume and difficult to process directly. The illustrative embodiments provide a method and apparatus for transforming the time series into distance data. This distance data may include distances that represent deviation from nominal performance. A matrix of these distances may be used as input for prognostic algorithms, such as machine learning algorithms, that predict system health. Further, these distances may aid visualization of the time series, such as indicating which time series are most informative.

Thus, the illustrative embodiments provide a method and apparatus for evaluating a component of a complex system, such as a vehicle, using time series. In one illustrative embodiment, a method for evaluating a component of a vehicle is provided. Time series data generated during operation of the vehicle is received by a computer system. The computer system transforms the time series data into a plurality of segments based on a selected state for the vehicle that is of interest. The computer system builds a prognostic distance matrix based on pairings formed using the plurality of segments. The prognostic distance matrix comprises distances that measure deviation of the component from the nominal performance for the selected state. The computer system generates a digital prognosis for the component of the vehicle based on the prognostic distance matrix. The digital prognosis predicts whether a maintenance operation should be performed with respect to the component.

The prognostic distance matrix comprises distances that measure deviation of the component from nominal performance for the selected state, and are therefore interpretable by subject matter experts. In training one or more machine learning algorithms, the distances may be related graphically to both the original time series and events of interest to help understand the problem and guide a solution. The one or more machine learning algorithms may then be deployed for prognostic and diagnostic purposes.

In one illustrative example, the prognostic distance matrix is input into a set of machine learning algorithms that generate prognostic indicators with respect to the health of a component. Generating prognostic indicators using distances that are computed based on segmented time series may be less time-consuming, less difficult, and more efficient than generating these prognostic indicators using a matrix created directly from the original time series. Additionally, the prognostic distance matrix reduces the overall volume of data that is used in evaluating the health of a component, while still allowing the generation of a digital prognosis that has a desired level of accuracy.

Predictions may be made based on these prognostic indicators and maintenance operations may be scheduled to help prevent undesired events, such as unhealthy states, inconsistencies, sub-optimal performance, unplanned part removals, unscheduled use interruptions, and other types of undesired events. Further, maintenance operations that will avoid operational inefficiencies may be performed based on the prognostic indicators. For example, operational inefficiencies such as excess fuel burn may be avoided.

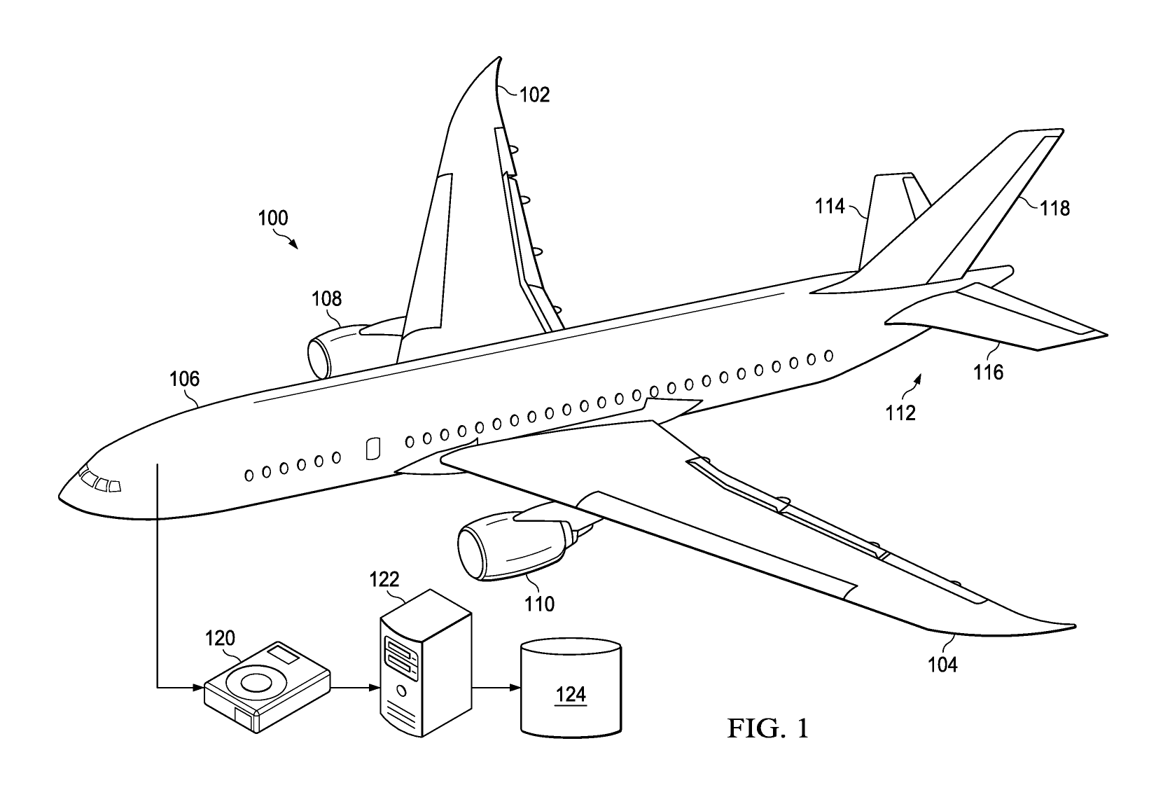

Referring now to the figures and, in particular, with reference to FIG. 1, an illustration of an aircraft is depicted in accordance with an illustrative embodiment. In this illustrative example, aircraft 100 has wing 102 and wing 104 attached to body 106. Further, aircraft 100 includes engine 108 attached to wing 102 and engine 110 attached to wing 104. Body 106 has tail section 112. Horizontal stabilizer 114, horizontal stabilizer 116, and vertical stabilizer 118 are attached to tail section 112 of body 106.

During flight, sensor data may be collected by, for example, without limitation, flight recorder 120. The sensor data collected by flight recorder 120 may be retrieved and stored in server system 122. Over time, the sensor data collected during each flight of aircraft 100 and stored in server system 122 may accumulate. As one illustrative example, during about one year of flights of aircraft 100, about 50 terabytes of sensor data 124 may be collected. In some illustrative examples, about 2 gigabytes to about 1000 gigabytes of sensor data 124 may be collected per flight.

The sensor data collected during the flight of aircraft 100 may include measurements for performance parameters that are generated multiple times during flight. In one illustrative example, aircraft 100 may collect measurements for about 1000 to about 2500 performance parameters per second.

Thus, the sensor data collected from flight recorder 120 over time may include multiple time series. A time series may be a time-ordered sequence of data points that typically include successive measurements made over a time interval. In many cases, the multiple time series may be irregular in that the time series have unequal sampling rates and are collected over varying flight durations. Consequently, accounting for these differences prior to processing of the data may reduce the overall time of processing.

The illustrative embodiments provide a health management system that is capable of processing and transforming one or more time series for aircraft 100 into segments. Each of these segments may correspond to a different selected state of interest for aircraft 100. Distances are then computed based on these segments. These distances may be used to create a prognostic distance matrix. The prognostic distance matrix may be input into a set of machine learning algorithms. This set of machine learning algorithms may evaluate the health of aircraft 100 or one or more components of aircraft 100 using the prognostic distance matrix to generate a digital prognosis about the health of aircraft 100.

This digital prognosis may predict whether or not a maintenance operation should be performed for aircraft 100. In some cases, the digital prognosis may indicate a time frame within which the maintenance operation should be performed. The maintenance operation may comprise at least one of inspection, preventative maintenance, corrective maintenance, adaptive maintenance, in-use maintenance, repair, rework replacement, or overhaul.

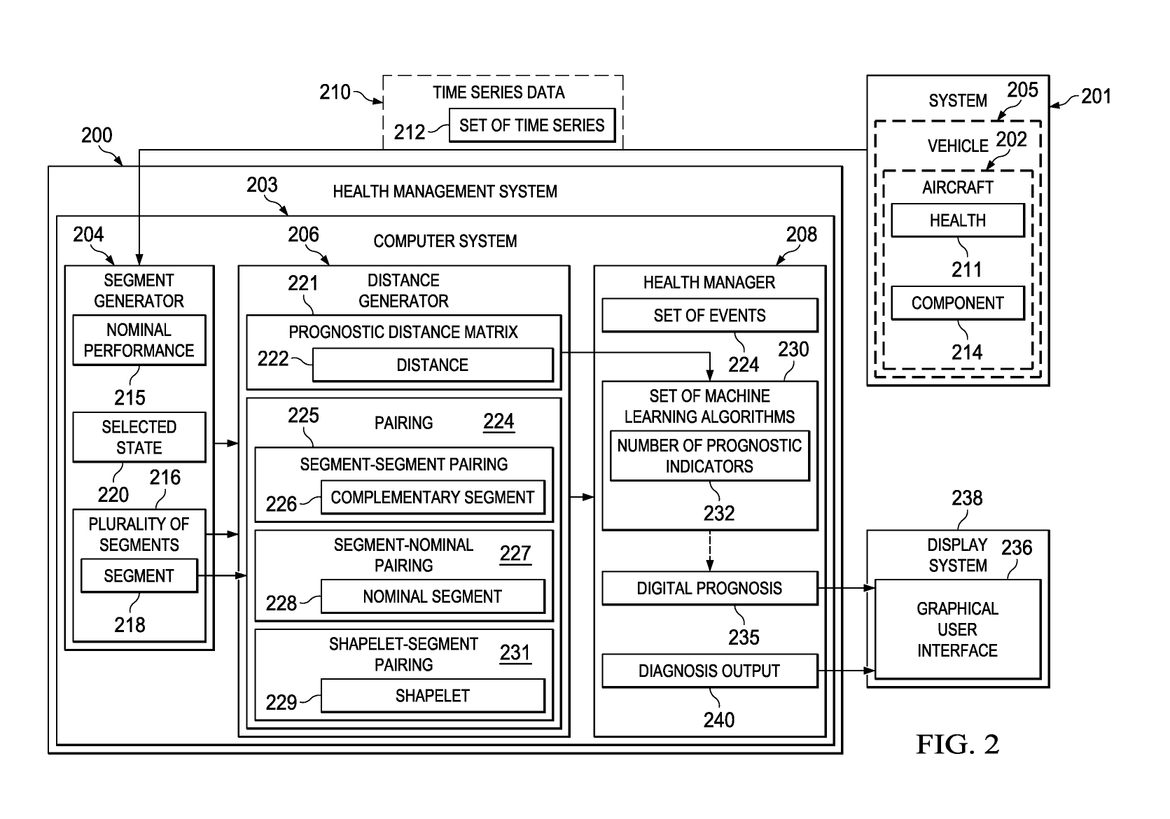

The prognostic distance matrix may also be used to create a visual report that may be displayed in a graphical user interface on a display system. A subject matter expert may use this visual report to diagnose why maintenance operations should be performed for aircraft 100. An example of one implementation for a health management system that may be used to evaluate the health of aircraft 100 is described in greater detail below in FIG. 2.

With reference now to FIG. 2, an illustration of a health management system is depicted in the form of a block diagram in accordance with an illustrative embodiment. Health management system 200 may be used to manage the health of system 201.

System 201 may be a complex system such as, but not limited to, vehicle 205. As one illustrative example, vehicle 205 takes the form of aircraft 202. In other illustrative examples, system 201 may take the form of a space vehicle, a water vehicle, a ground vehicle, a computer station, a manufacturing facility, a robotic system, or some other type of system.

The health of system 201 may include a status of the entirety of system 201, the various components that make up system 201, or a combination thereof. As used herein, a component of a complex system, such as system 201, may be a subsystem, an assembly, a subassembly, an individual part, a sensor, a sensor system, a computer system, an electronic system, an electromechanical system, a communications system, some other type of element that makes up the complex system, or a combination thereof.

In one illustrative example, health management system 200 may be implemented using computer system 203. Computer system 203 may comprise a single computer or multiple computers that are in communication with each other. Below, the implementation of health management system 200 is described with respect to system 201 in the form of aircraft 202. However, a similar implementation may be used for system 201 in the form of a different type of vehicle or other type of complex system.

In one illustrative example, health management system 200 includes segment generator 204, distance generator 206, and health manager 208. In this illustrative example, segment generator 204, distance generator 206, and health manager 208 may take the form of modules that are implemented in computer system 203. For example, segment generator 204, distance generator 206, and health manager 208 may take the form of a segment generator module, a distance generator module, and a health manager module, respectively.

A module, as used herein, may be implemented in software, hardware, firmware, or a combination thereof. When software is used, the operations performed by the module may be implemented using, for example, without limitation, program code configured to run on a processor unit. When firmware is used, the operations performed by the module may be implemented using, for example, without limitation, program code and data and stored in persistent memory to run on a processor unit.

When hardware is employed, the hardware may include one or more circuits that operate to perform the operations performed by the module. Depending on the implementation, the hardware may take the form of a circuit system, an integrated circuit, an application specific integrated circuit (ASIC), a programmable logic device, or some other suitable type of hardware device configured to perform any number of operations.

A programmable logic device may be configured to perform certain operations. The device may be permanently configured to perform these operations or may be reconfigurable. A programmable logic device may take the form of, for example, without limitation, a programmable logic array, a programmable array logic, a field programmable logic array, a field programmable gate array, or some other type of programmable hardware device.

In some illustrative examples, the operations and/or processes performed by the module may be performed using organic components integrated with inorganic components. In some cases, the operations and/or processes may be performed by entirely organic components, excluding a human being. As one illustrative example, circuits in organic semiconductors may be used to perform these operations and/or processes.

As depicted, segment generator 204 receives time series data 210 that may be used to manage health 211 of aircraft 202. Time series data 210 may be generated during operation of aircraft 202. Depending on the implementation, health management system 200 may be used to manage health 211 of a single component of system 201, multiple components of aircraft 202, or the entirety of aircraft 202.

Time series data 210 may include set of time series 212. As used herein, a “set of” items may include one or more items. In this manner, set of time series 212 may include one time series or multiple time series. A time series may be a time-ordered sequence of data points that typically include successive measurements made over a time interval. Time series data 210 may include measurements of at least one performance parameter related to health 211 of aircraft 202.

Time series data 210 may be formed from any number of different sources of data. In one illustrative example, time series data 210 may include sensor data generated on board aircraft 202 during a most recent flight of aircraft 202, past sensor data generated over some number of previous flights, or both.

In one illustrative example, time series data 210 is used to manage health 211 of component 214 in aircraft 202. Managing health 211 of component 214 in aircraft 202 may include different types of actions or operations. For example, without limitation, managing health 211 of component 214 may include at least one of acquiring time series data 210, transforming time series data 210, analyzing time series data 210, forming a diagnosis based on time series data 210, making predictions about health 211 of component 214 based on time series data 210, or some other type of action.

As used herein, the phrase “at least one of,” when used with a list of items, means different combinations of one or more of the listed items may be used and only one of the items in the list may be needed. The item may be a particular object, thing, step, operation, process, or category. In other words, “at least one of” means any combination of items or number of items may be used from the list, but not all of the items in the list may be required.

For example, without limitation, “at least one of item A, item B, or item C” or “at least one of item A, item B, and item C” may mean item A; item A and item B; item B; item A, item B, and item C; item B and item C; or item A and C. In some cases, “at least one of item A, item B, or item C” or “at least one of item A, item B, and item C” may mean, but is not limited to, two of item A, one of item B, and ten of item C; four of item B and seven of item C; or some other suitable combination.

Segment generator 204 may transform time series data 210 into plurality of segments 216 for use in evaluating health 211 of component 214. In particular, time series data 210 may be transformed into plurality of segments 216 based on at least one selected state 220 for aircraft 202 that is of interest.

Selected state 220 may be a state of operation for aircraft 202. In some cases, selected state 220 may be referred to as an operational regime for aircraft 202. For example, without limitation, selected state 220 may be an entire flight of aircraft 202, a particular phase of flight of aircraft 202, a selected portion of a flight of aircraft 202, a selected time period during a flight of aircraft 202, a selected time period after a number of commands are sent from an aircraft control system to component 214, or some other state of operation.

As used herein, a “number of” items may include one or more items. In this manner, a number of commands may include one or more commands.

Selected state 220 may be of interest because evaluating segments that correspond to a same selected state 220 will ensure that these segments are comparable and useful in distinguishing when component 214 is performing nominally and when component 214 is not performing nominally. In particular, selected state 220 may be selected such that a comparison of two segments that correspond to selected state 220 may be used to distinguish when component 214 is performing nominally and when component 214 is not performing nominally. In these illustrative examples, nominal performance 215 for component 214 may be at least one of expected performance, performance that is within selected tolerances, performance that provides desired fuel efficiencies, performance that provides desired performance of the entirety of aircraft 202, healthy behavior, normal behavior, or some other type of standard behavior.

A segment, such as segment 218 in plurality of segments 216, that corresponds to selected state 220 may be a portion of data that was generated or acquired during selected state 220. For example, selected state 220 may be a cruise phase of flight and a corresponding segment may be a portion of time series data 210 that was generated or acquired during that cruise phase of flight.

In some cases, selected state 220 may occur once per flight of aircraft 202. In other cases, selected state 220 may occur multiple times per flight of aircraft 202. In still other illustrative examples, a segment, such as segment 218, may be the combination of any and all portions of data that correspond to the same selected state 220 for a particular flight.

In some illustrative examples, selected state 220 may be specific to component 214. For example, without limitation, when component 214 takes the form of a brake system of aircraft 202, selected state 220 may be the portion of a flight of aircraft 202 just after landing.

Plurality of segments 216 may be sent to distance generator 206 for processing. Distance generator 206 transforms plurality of segments 216 into prognostic distance matrix 221. Prognostic distance matrix 221 may be a matrix that comprises distances computed based on pairings.

For example, without limitation, distance 222 may be computed for pairing 224. Pairing 224 may take a number of different forms. In these illustrative examples, pairing 224 may be a pairing of a first portion of data with a second portion of data from which distance 222 may be computed. Distance 222 may measure a deviation from nominal performance by measuring differences between the first portion of data and the second portion of data.

A first type of pairing 224 may take the form of segment-segment pairing 225. Segment-segment pairing 225 may be a pairing between two segments of plurality of segments 216, both of which correspond to the same selected state 220. Segment-segment pairing 225 is selected such that distance 222 computed based on segment-segment pairing 225 may help distinguish between nominal performance and non-nominal performance.

For example, segment-segment pairing 225 may be between segment 218 and complementary segment 226. Segment 218 may comprise data generated by a first sensor during selected state 220 for a particular flight. Complementary segment 226 may comprise data generated by a second sensor during selected state 220 for the particular flight. It may be known that comparing the first sensor to the second sensor during selected state 220 of the particular flight may enable distinguishing between nominal performance and non-nominal performance. Distance 222 may be computed by comparing segment 218 to complementary segment 226.

A second type of pairing 224 may take the form of segment-nominal pairing 227 between a segment, such as segment 218, and nominal segment 228. In this example, nominal segment 228 represents nominal performance. Nominal segment 228 may comprise data previously generated, historical data, or expected data that corresponds to selected state 220. For example, a database of expected sensor values may be used to identify expected values for selected state 220. These expected values may be normalized or otherwise transformed to form nominal segment 228. Distance 222 may be computed by comparing segment 218 to nominal segment 228.

In some cases, nominal segment 228 may be formed by estimating values for selected state 220. For example, historical data may be used to estimate values to form nominal segment 228.

A third type of pairing 224 may be shapelet-segment pairing 231, which may be between shapelet 229 and a segment, such as segment 218. When it is known that a segment that represents non-nominal performance varies only in localized sections from a segment that represents nominal performance, shapelet 229 may be used to compute distance 222 for that segment.

Shapelet 229 may be a subsequence that may be present in non-nominal performance or nominal performance but not both. Consequently, shapelet 229 may be used to distinguish when segment 218 indicates nominal performance and when segment 218 indicates non-nominal performance.

Shapelet 229 may be identified for use in analyzing segment 218 in a number of different ways. In one illustrative example, shapelet 229 may be a local section within segment 218 that is identified as being representative of non-nominal performance or nominal performance. In another illustrative example, shapelet 229 may be identified through training based on previously collected data. For example, without limitations, prior segments that have been identified as representing performance that is not nominal may be searched to find a localized section that is in segments of non-nominal performance, but not in segments of nominal performance. In other illustrative examples, multiple localized sections from various segments or from within a single segment may be processed and used as a set of shapelets.

Distance 222 may be computed between each pairing of shapelet 229 and one of a plurality of sections of segment 218. Each section in this plurality of sections may be different. But, depending on the implementation, at least a portion of the plurality of sections may overlap. The smallest distance that is computed may represent a best match between shapelet 229 and a corresponding section of segment 218. This smallest distance may be selected as distance 222 for shapelet-segment pairing 231.

Distance generator 206 may compute the distances that form prognostic distance matrix 221 in a number of different ways. Any number of algorithms, statistical formulas, equations, models, or combination thereof may be used to compute the distances that form prognostic distance matrix 221. For example, these distances may be computed using different types of distance measures, which include, but are not limited to, lock-step distance measures, elastic distance measures, shape-based distance measures, threshold distance measures, and other distance measures.

For example, lock-step distance measures may include Euclidean distance and complexity invariant Euclidian distance. Elastic distance measures may include edit distance on real sequences (EDR), edit distance with real penalty (EPR), longest common subsequences (LOSS), and dynamic time warping (DTW). Shape-based distance measures may include derivative dynamic time warping and feature-based dynamic time warping. The Short Time Series approach and the Dissimilarity approach both take into account different sampling rates.

In one illustrative example, prognostic distance matrix 221 may comprise distances computed for segment-segment pairings for each distance type of a number of different distance types. These distances may be computed for each selected state of a number of selected states to form prognostic distance matrix 221.

In another illustrative example, prognostic distance matrix 221 may comprise distances computed for segment-nominal pairings for a number of different parameters for each selected state in a number of selected states. In yet another illustrative example, prognostic distance matrix 221 may include distances for shapelet-segment pairings for a number of different types of shapelets for each selected state of a number of different selected states. Further, these distances may be computed for each parameter of a number of different parameters.

Prognostic distance matrix 221 may be output from distance generator 206 and sent into health manager 208 as input for further analysis. By transforming plurality of segments 216 into prognostic distance matrix 221, the volume of data input into health manager 208 is reduced.

Health manager 208 uses prognostic distance matrix 221 as an input for set of machine learning algorithms 230. Set of machine learning algorithms 230 may include at least one algorithm that can learn from and make predictions on data based on at least one of supervised learning, unsupervised learning, reinforcement learning, anomaly detection, or some other type of learning.

Set of machine learning algorithms 230 may generate number of prognostic indicators 232 for component 214. Each prognostic indicator in number of prognostic indicators 232 is a prediction of a likely outcome or future status for component 214 with respect to the performance or health of component 214. For example, without limitation, a prognostic indicator in number of prognostic indicators 232 may signpost that an undesired event related to the performance or health of component 214 may occur within a specified period of time. The undesired event may be a component failure, a component fault, an operational inefficiency, or some other type of undesired event.

As one specific illustrative example, a prognostic indicator may signpost that component 214 may need to be replaced in about 15 days in order to maintain a desired level of performance for component 214 and a desired level of fuel efficiency for aircraft 202. As another illustrative example, a prognostic indicator may indicate that component 214 will need to be serviced in about 2 months in order to maintain a desired level of performance for component 214 and a desired level of performance for aircraft 202.

Health manager 208 may generate an output in the form of digital prognosis 235 based on number of prognostic indicators 232. Digital prognosis 235 may be presented to a user in a number of different ways. For example, without limitation, a visual representation of digital prognosis 235 is displayed in graphical user interface 236 on display system 238 for a user. Display system 238 may comprise any number of display devices that are in communication with each other, in communication with computer system 203, or both. In this illustrative example, display system 238 may be considered separate from computer system 203. However, in other illustrative examples, display system 238 may be considered part of computer system 203.

In some illustrative examples, health manager 208 may generate an output in the form of diagnosis output 240, which may be based directly on the distances in prognostic distance matrix 221. Diagnosis output 240 may be used by, for example, without limitation, a subject matter expert, to diagnose any issues that have been indicated by digital prognosis 235.

As time series data 210 is collected and processed over time, new segments may be selected and added to collection of segments 241. Distance generator 206 may add each distance computed to distance data 242 for collection of segments 241.

In some cases, health manager 208 may use distance data 242 to form input for set of machine learning algorithms 230. Health manager 208 may then generate digital prognosis 235 that is at least one of based directly on distance data 242, based indirectly on distance data 242, based on the various prognostic indicators generated by set of machine learning algorithms 230, or based on some other type of algorithm.

Prior to set of machine learning algorithms 230 being used, set of machine learning algorithms 230 may be trained. Training may include using big data algorithms based on, for example, without limitation, Hadoop® provided by Apache™, MapReduce, Spark, some other type of computing software, or a combination thereof. Batches of historical data may be processed in a manner similar to that described above. When deployed, streaming algorithms may be used as aircraft 202 completes flight. Time series data 210 may be acquired, segments created, distances computed, and a digital prognosis generated in real time.

As part of training, health manager 208 identifies set of events 244 related to component 214. Set of events 244 may be a set of events that are of interest with respect to health 211 of component 214. An event in set of events 244 may include, for example, without limitation, at least one of a maintenance event, a scheduled interruption, an inspection, a system repair, a part replacement, an upgrade, or some other type of event related to health 211 of system 201. Set of events 244 may be used as markers to help choose the input distances and understand the output from set of machine learning algorithms 230 as set of machine learning algorithms 230 is being trained.

In one illustrative example, health manager 208 identifies set of events 244 based on user input. In another illustrative example, health manager 208 receives an identification of set of events 244 from the output of one or more algorithms. For example, without limitation, a number of algorithms may be used to analyze at least one of service reports, repair reports, maintenance records, interruption records, or other types of information to identify set of events 244. In one illustrative example, identifying set of events 244 includes identifying the time at which each event in set of events 244 occurred.

The illustration of health management system 200 in FIG. 2 is not meant to imply physical or architectural limitations to the manner in which an illustrative embodiment may be implemented. Other components in addition to or in place of the ones illustrated may be used. Some components may be optional. Also, the blocks are presented to illustrate some functional components. One or more of these blocks may be combined, divided, or combined and divided into different blocks when implemented in an illustrative embodiment.

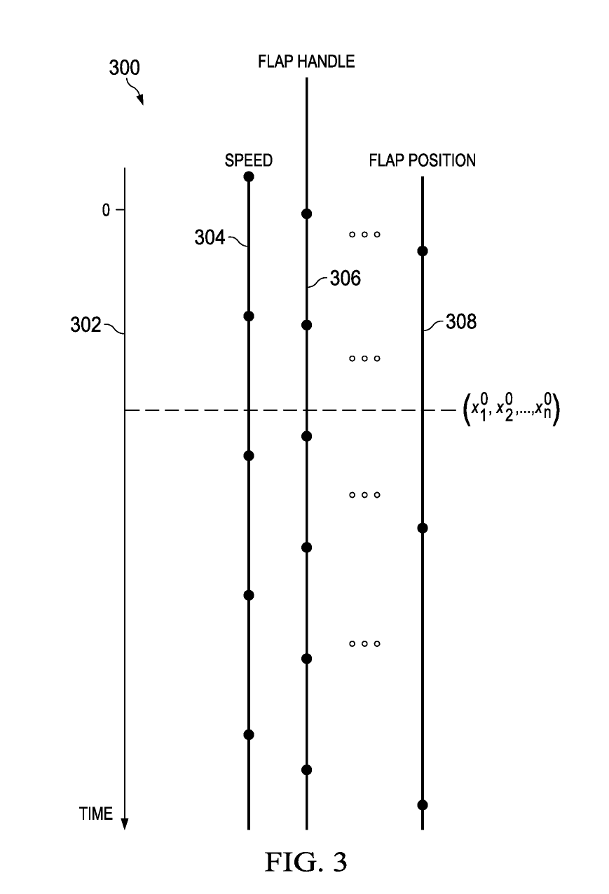

With reference now to FIG. 3, an illustration of a set of time series is depicted in accordance with an illustrative embodiment. In this illustrative example, set of time series 300 is displayed with respect to time axis 302. Set of time series 300 may be an example of one implementation for set of time series 212 in FIG. 2.

As depicted, set of time series 300 includes speed times series 304, flap handle time series 306, and flap position time series 308. Speed time series 304 may include measurements of the speed of an aircraft, such as aircraft 100 in FIG. 1, during the flight of the aircraft. Flap handle time series 306 may include measurements of the position of the control handle that controls flap position during the flight of the aircraft. Further, flap position time series 308 may include measurements of flap position during the flight of the aircraft.

Although each time series in set of times series 300 comprises successive measurements taken over time, these measurements are not all taken at the same points in time. Further, the sampling frequencies for each time series may differ. Processing set of time series 300 generated over multiple flights by segmenting set of time series 300 and computing distances in the manner described in FIG. 2 above may produce effective features for later prognostic activities and better represent information in the data to match analysis goals.

Creating segments based on set of time series 300 and computing distances based on these segments may help reduce overall processing time, make processing easier, and keep processing consistent. In particular, inputting a prognostic distance matrix into machine learning algorithms as compared to a matrix created directly based on the set of time series 300 may reduce the volume of data that needs to be input into the machine learning algorithms to generate prognostic indicators for a component, such as component 214.

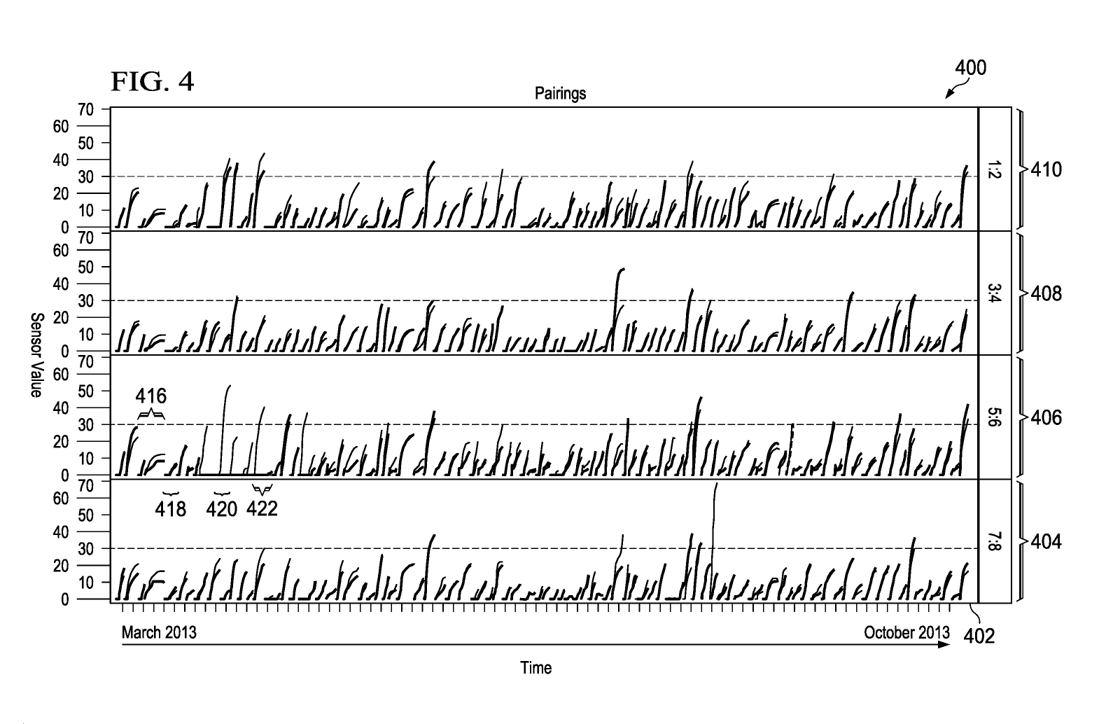

With reference now to FIG. 4, an illustration of a graph of pairings is depicted in accordance with an illustrative embodiment. In this illustrative example, graph 400 illustrates pairings with respect to time axis 402.

As depicted, graph 400 illustrates first plurality of pairings 404, second plurality of pairings 406, third plurality of pairings 408, and fourth plurality of pairings 410. Each of first plurality of pairings 404, second plurality of pairings 406, third plurality of pairings 408, and fourth plurality of pairings 410 includes a plurality of segment-segment pairings, similar to segment-segment pairing 225 in FIG. 2.

For example, second plurality of pairings 406 includes segment-segment pair 416, segment-segment pair 418, segment-segment pair 420, and segment-segment pair 422. These segment-segment pairings may be examples of implementations for segment-segment pairing 225 in FIG. 2.

In one illustrative example, each segment-segment pairing in graph 400 represents a pairing of brake systems. For example, each segment-segment pairing in second plurality of pairings 406 may include a first segment that represents temperature for a first rear brake system and a second segment that represents temperature for a second rear brake system, respectively, of an aircraft. These two segments correspond to the same selected state of interest, which may be a period of time just after landing in this illustrative example.

The temperature of a brake system after landing may be a performance parameter that is known to be indicative of the health of the brake system. Although temperature measurements may be collected throughout the duration of each flight of an aircraft, in some cases, only the period of time just after landing may be of interest in evaluating the health of a brake system.

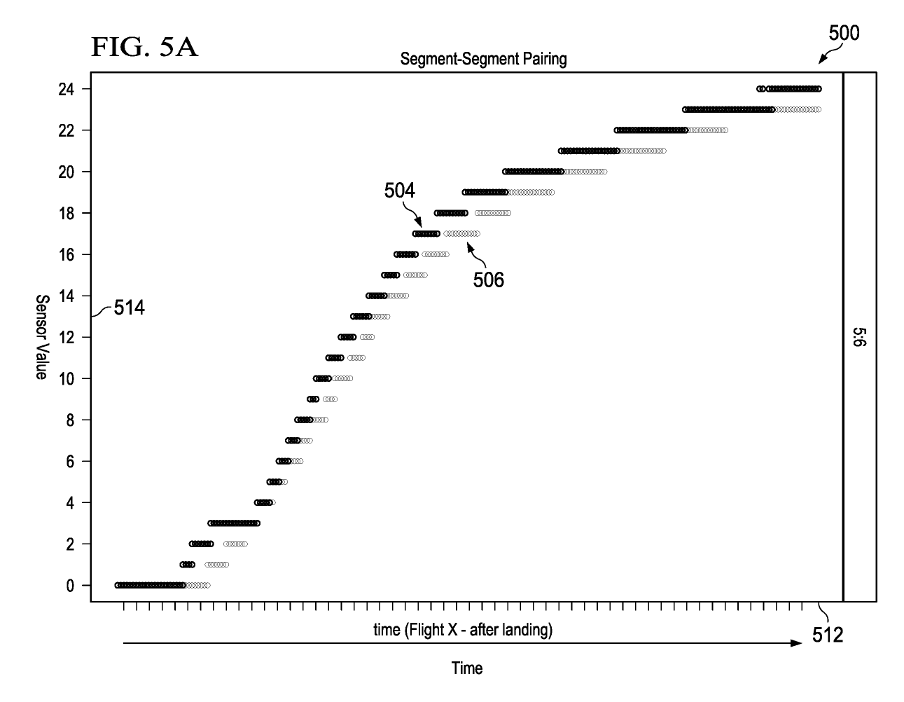

With reference now to FIGS. 5A and 5B, illustrations of a segment-segment pairing that is healthy and a segment-segment pairing that is not healthy are depicted in accordance with an illustrative embodiment. In this illustrative example, segment-segment pairing 500 and segment-segment pairing 502 are shown. Segment-segment pairing 500 and segment-segment pairing 502 may each be an example of one implementation for segment-segment pairing 225 in FIG. 2.

The segments shown in segment-segment pairing 500 and segment-segment pairing 502 may have been formed by a segment generator, such as segment generator 204 in FIG. 2. Segment-segment pairing 500 includes first segment 504 and second segment 506, which may be portions of data from a first time series and a second time series, respectively. Segment-segment pairing 502 includes first segment 508 and second segment 510, which may be portions of data from a first time series and a second time series, respectively. In one illustrative example, segment-segment pairing 500 and segment-segment pairing 502 are selected from second plurality of pairings 406 in FIG. 4.

In this illustrative example, the first time series may include temperature measurements for a first brake system and the second time series may include temperature measurements for a second brake system. The first time series and the second time series may be considered complementary time series.

As depicted, the data in segment-segment pairing 502 was generated at a later time than the data in segment-segment pairing 500. Segment-segment pairing 500 is depicted with respect to time axis 512 and sensor value axis 514. In this illustrative example, first segment 504 and second segment 506 of segment-segment pairing 500 correspond to a first flight of an aircraft. In particular, first segment 504 and second segment 506 were generated during the same period of time during this flight just after landing. As depicted, first segment 504 and second segment 506 follow each other closely.

Segment-segment pairing 502 is depicted with respect to time axis 516 and sensor value axis 518. In this illustrative example, first segment 508 and second segment 510 of segment-segment pairing 502 correspond to a second flight of the aircraft. In particular, first segment 508 and second segment 510 were generated during the same period of time during this flight just after landing.

Thus, the segments in both segment-segment pairing 500 and segment-segment pairing 502 correspond to the same selected state of interest, which is the period of time just after landing. In other words, both segment-segment pairing 500 and segment-segment pairing 502 are comparable in that both include segments that comprise data collected at a common operational regime: after landing.

A distance generator, such as distance generator 206 in FIG. 2, may compute distances between the segments in segment-segment pairing 500 and the segments in segment-segment pairing 502. The distance computed for a segment-segment pairing measures a deviation from nominal performance. In this illustrative example, nominal performance may be that the temperatures of both brake systems have similar values when both brake systems are performing nominally. This is because two brake systems have been chosen that should operate similarly when performing nominally. Equivalently, the distance computed between segment-segment pairings should be relatively small when both brake systems are performing nominally.

The distance computed for the segments within segment-segment pairing 500 would indicate a lesser deviation from nominal performance. The distance computed for the segments within segment-segment pairing 502 would indicate a greater deviation from nominal performance.

Different types of distances may be computed for segment-segment pairing 500 and segment-segment pairing 502. For example, distances could include distances currently available in the field of time series data mining. In some illustrative examples, distances could be custom-designed. For example, without limitation, a custom algorithm or formula may be created to compute a certain type of distance.

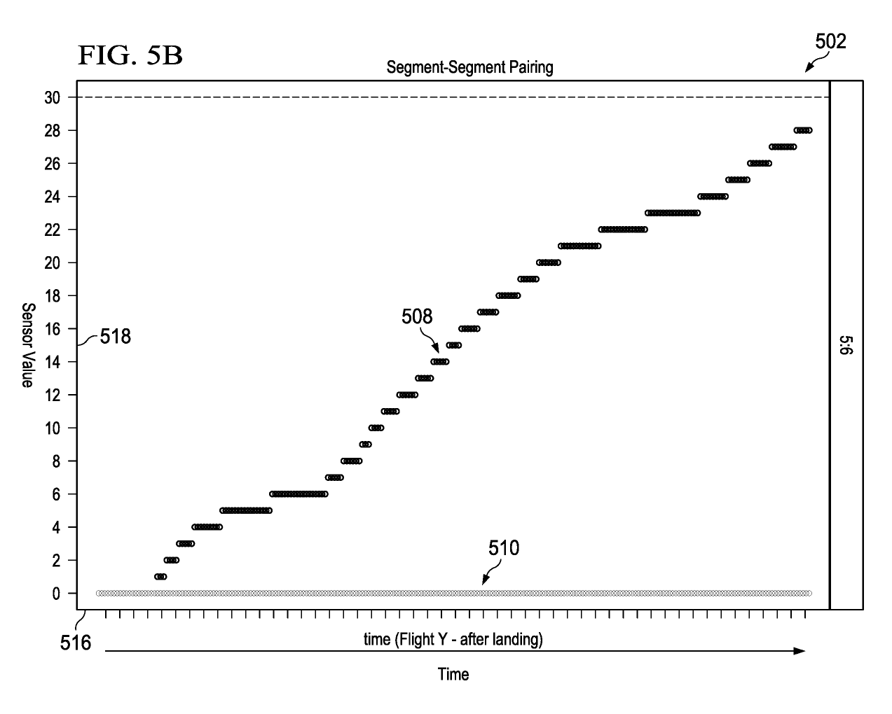

With reference now to FIG. 6, an illustration of a plot of distances over time is depicted in accordance with an illustrative embodiment. In this illustrative example, plot 600 of distances 601 for various pairings is shown with respect to flight number axis 602.

Distances 601 are shown for sensor pair 604, sensor pair 606, sensor pair 608, sensor pair 610, and sensor pair 612. In this illustrative example, each sensor pair may be a pairing of two sensors on an aircraft that are expected to generate substantially the same measurements or measurements that differ by a small constant when both sensors are healthy. However, the sampling rates of the two sensors differ. Therefore, a distance from expected is calculated.

For example, for sensor pair 604, first distances 614 represent the distances computed between segments for a first sensor in sensor pair 604 and nominal segments. Second distances 616 represent the distances computed between segments for a second sensor in sensor pair 604 and nominal segments.

In this illustrative example, portion 618 of first distances 614 diverge from second distances 616, thereby indicating a problem with the first sensor. This problem increases before line 620, which marks a maintenance event. The maintenance event was the replacement of the first sensor. Portion 622 of first distances 614 represents the flights after the maintenance event and shows that the replacement sensor began operating nominally after the maintenance event.

In these illustrative examples, the maintenance event represented by line 620 may have been performed in response to an output from a health management system, such as health management system 200 in FIG. 2. The output included a prognosis for the sensor, which indicated that the sensor was not operating nominally and that the sensor should be replaced within a specified period of time to prevent the sensor from failing during operation of the aircraft. At the time of the prognosis, plot 600 may have been used to diagnose which sensor of sensor pair 604 was having a problem.

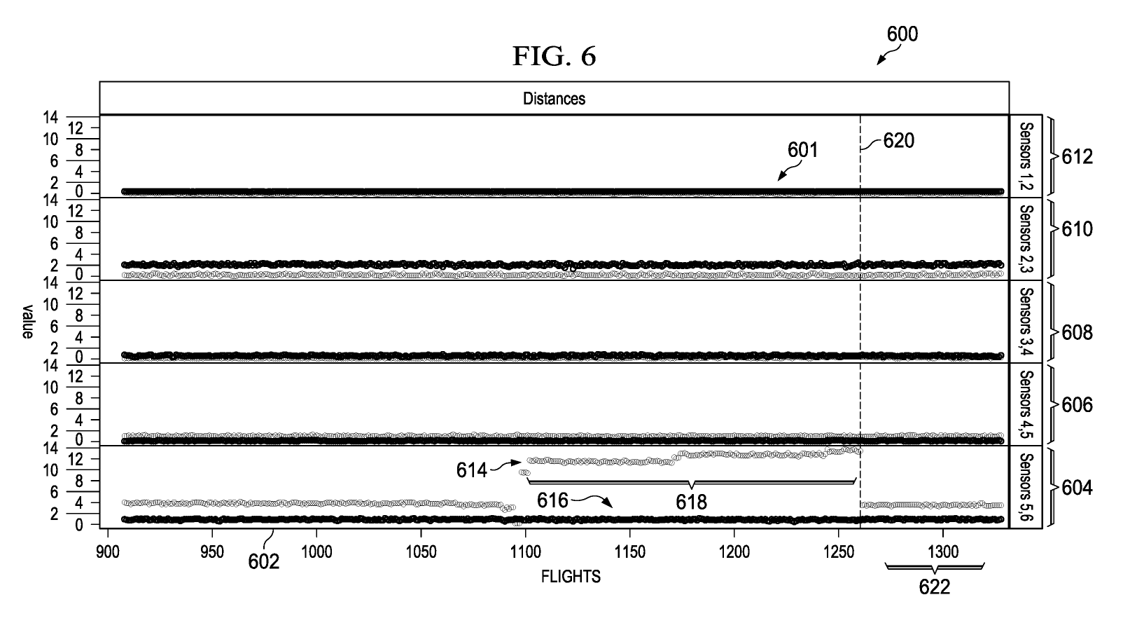

With reference now to FIG. 7, an illustration of a shapelet and a segment is depicted in accordance with an illustrative embodiment. In this illustrative example, segment 700 may be an example of one implementation for segment 218 in FIG. 2. Shapelet 702 may be a section that represents local, non-nominal performance. Shapelet 702 may also be referred to as a subsequence.

Shapelet 702 may be used to compute a distance for a shapelet-segment pairing involving segment 700 by sliding shapelet 702 down along segment 700 in the direction of arrow 704 to form various pairs between shapelet 702 and a plurality of sections of segment 700. These local sections may or may not overlap. A distance is computed for each pairing of shapelet 702 and a local section of segment 700. These distances may then be used to compute an overall distance for the shapelet-segment pairing. In one illustrative example, the smallest of these distances is used as the overall distance for the shapelet-segment pairing.

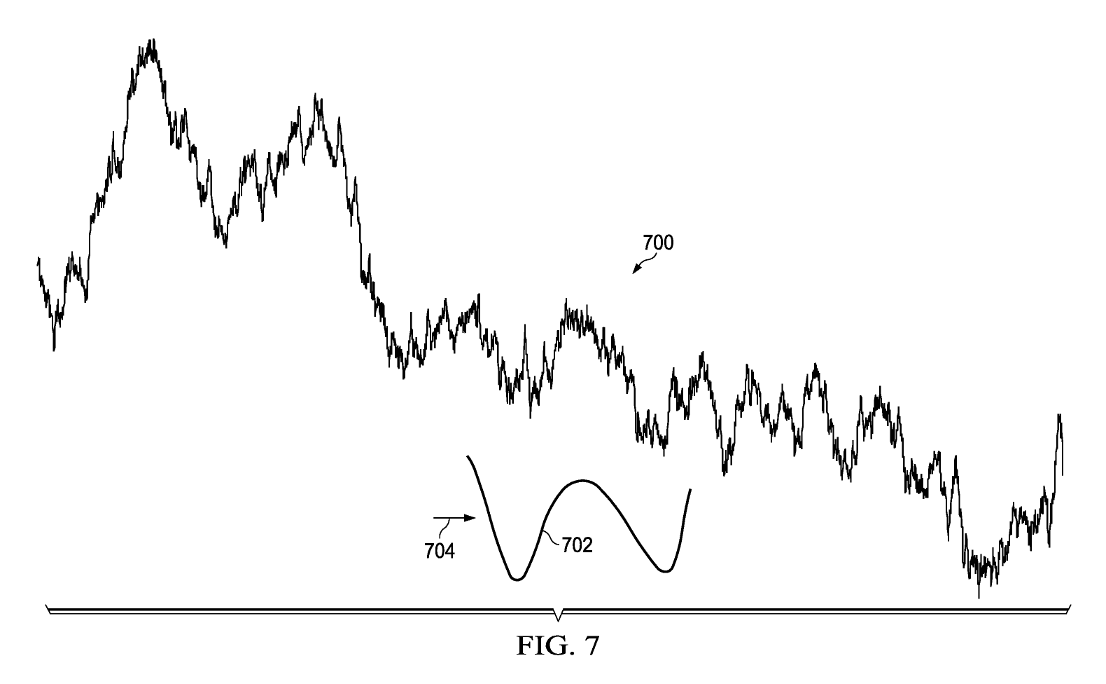

With reference now to FIG. 8, an illustration of a prognostic distance matrix for segment-nominal pairings is depicted in accordance with an illustrative embodiment. In FIG. 8, prognostic distance matrix 800 is an example of one implementation for prognostic distance matrix 221 in FIG. 2.

Prognostic distance matrix 800 comprises distances for segment-nominal pairings. In some cases, prognostic distance matrix 800 may be referred to as a nominal-based prognostic distance matrix.

In this illustrative example, prognostic distance matrix 800 comprises distances for various flights in flights 802. In particular, these distances are computed for selected states 804 of flights 802. Selected states 804 may include S states, ranging from State 1 806 to State S 808.

Prognostic distance matrix 800 includes a submatrix for each of selected states 804. For example, prognostic distance matrix 800 includes submatrix 810 for State 1 806 and submatrix 812 for State S 808.

In particular, for each of flights 802, submatrix 810 includes a distance computed for one of P parameters with respect to State 1 806. For example, each column of submatrix 810 comprises, for each one of flights 802, a distance between a nominal segment and a segment extracted from time series data for a particular parameter during State 1 806 for the corresponding flight.

Column 814 comprises a distance between a segment extracted from time series data for parameter 1 during State 1 806 for the corresponding flight and a nominal segment that represents nominal values for parameter 1 during State 1 806. Column 816 comprises a distance between a segment extracted from time series data for parameter P during State 1 806 for the corresponding flight and a nominal segment that represents nominal values for parameter P during State 1 806.

Further, column 818 of submatrix 812 comprises a distance between a segment extracted from time series data for parameter 1 during State S 808 for the corresponding flight and a nominal segment that represents nominal values for parameter 1 during State S 808. Column 820 of submatrix 812 comprises a distance between a segment extracted from time series data for parameter P during State S 808 for the corresponding flight and a nominal segment that represents nominal values for parameter P during State S 808.

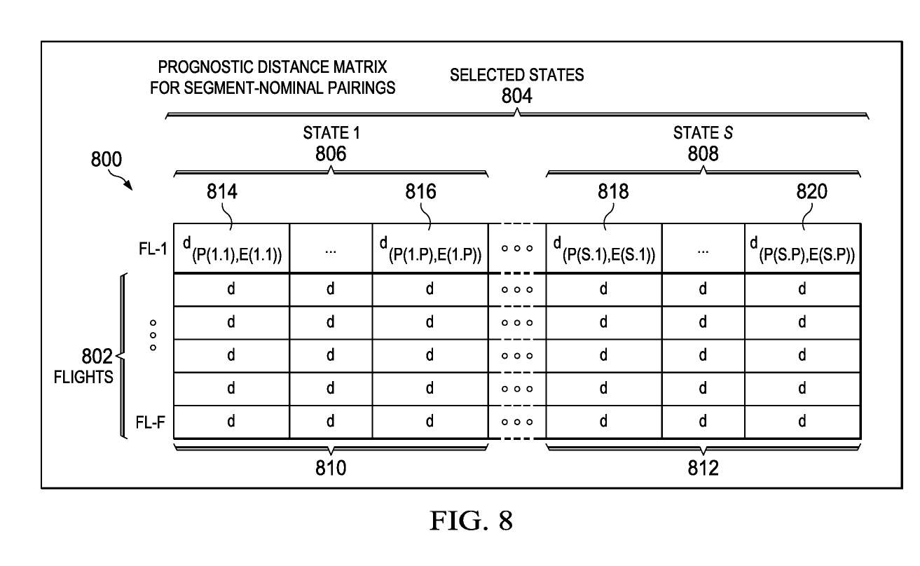

With reference now to FIG. 9, an illustration of a prognostic distance matrix for segment-segment pairings is depicted in accordance with an illustrative embodiment. In FIG. 9, prognostic distance matrix 900 is an example of one implementation for prognostic distance matrix 221 in FIG. 2.

Prognostic distance matrix 900 comprises distances for segment-segment pairings. In some cases, prognostic distance matrix 900 may be referred to as a segment-based prognostic distance matrix. The different segment-segment pairings represented by prognostic distance matrix 900 may represent sensor pairs.

In this illustrative example, prognostic distance matrix 900 comprises distances for various flights in flights 902. In particular, these distances are computed for selected states 904 of flights 902. Selected states 904 may include S states, ranging from State 1 906 to State S 908.

For each selected state, prognostic distance matrix 900 includes a set of submatrices for M distance types 910 ranging from distance type 1 912 to distance type M 914. Thus, for each selected state of selected states 904, prognostic distance matrix 900 includes a submatrix for each distance type of distance types 910. For example, prognostic distance matrix 900 includes submatrix 916 for distance type 1 912 and submatrix 918 for distance type M 914.

In particular, for each of flights 902, submatrix 916 includes a distance computed for a sensor pair with respect to distance type 1 912 and State 1 906. For example, each column of submatrix 916 comprises, for each one of flights 902, a distance of distance type 1 912 between two segments extracted from time series data for two sensors during State 1 906 for the corresponding flight.

Column 920 comprises a distance of distance type 1 912 for data for a first sensor pair corresponding to State 1 906 for the corresponding flight. Column 922 comprises a distance of distance type 1 912 for data for a k^{th} sensor pair corresponding to State 1 906 for the corresponding flight.

Further, column 924 of submatrix 918 comprises a distance of distance type M 914 for a first sensor pair corresponding to State 1 906 for the corresponding flight. Column 926 of submatrix 918 comprises a distance of distance type M 914 for data from a k^{th} sensor pair corresponding to State 1 906 for the corresponding flight.

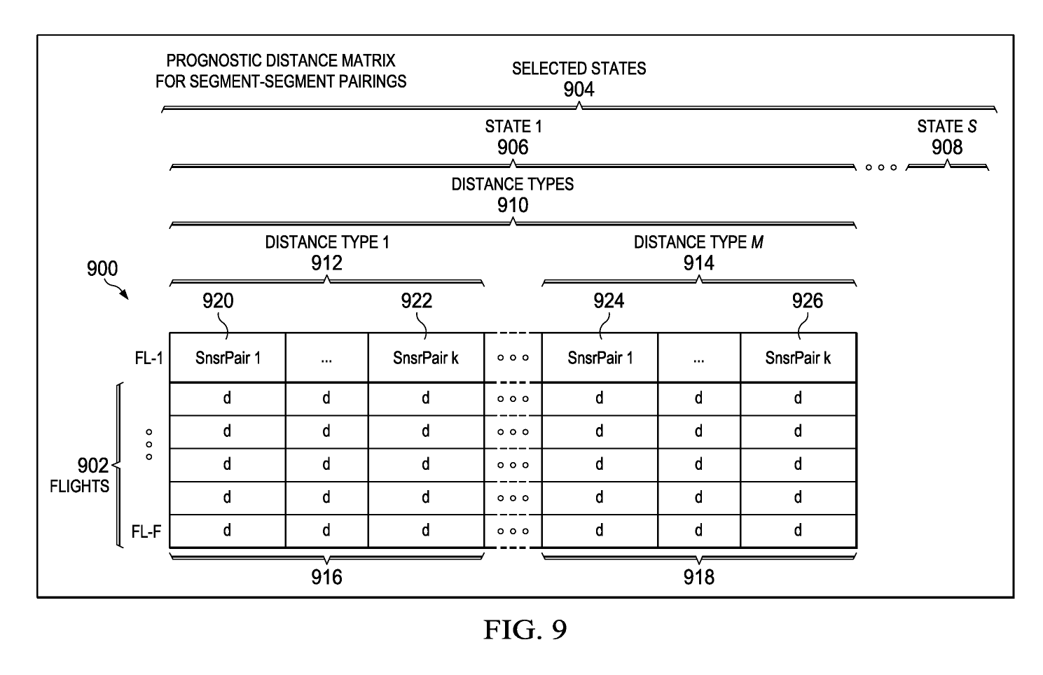

With reference now to FIG. 10, an illustration of a prognostic distance matrix for shapelet-segment pairings is depicted in accordance with an illustrative embodiment. In FIG. 10, prognostic distance matrix 1000 is an example of one implementation for prognostic distance matrix 221 in FIG. 2.

Prognostic distance matrix 1000 comprises distances for shapelet-segment pairings. In some cases, prognostic distance matrix 1000 may be referred to as a shapelet-based prognostic distance matrix.

In this illustrative example, prognostic distance matrix 1000 comprises distances for various flights in flights 1002. In particular, these distances are computed for P parameters 1004. Parameters 1004 range from parameter 1 1006 to parameter P 1008.

For each parameter of the P parameters 1004, prognostic distance matrix 1000 includes a set of submatrices for selected states 1010. Selected states 1010 range from State 1 1011 to State S 1012.

Prognostic distance matrix 1000 includes a submatrix for each of selected states 1010. For example, prognostic distance matrix 1000 includes submatrix 1014 for State 1 1011 and submatrix 1016 for State S 1012.

In particular, for each of flights 1002, submatrix 1014 includes distances computed for various shapelet-segment pairings. For example, for each selected state of selected states 1010, some number of shapelets may be identified. For State 1 1011, 1k shapelets may be identified for use. For State S 1012, Sk shapelets may be identified for use. Depending on the implementation, 1k may be the same in number or different in number from Sk.

Each selected state for a particular parameter corresponds to a particular segment. In one illustrative example, State 1 1011 for parameter 1 1006 corresponds to a first segment that was extracted from time series data capturing parameter 1 1006 during State 1 1011. State S 1012 for parameter 1 1006 corresponds to a second segment that was extracted from time series data capturing parameter 1 1006 during State S 1012.

Each column of submatrix 1014 for State 1 1011 comprises, for each one of flights 1002, a distance for a pairing of a particular shapelet and the first segment. This distance may be, for example, the minimum distance of the distances computed for the pairings of the shapelet with different sections of the first segment.

Column 1018 comprises a distance for a shapelet-segment pairing between a first shapelet and the first segment for State 1 1011 of the corresponding flight. Column 1020 comprises a distance for a shapelet-segment pairing between a 1k^{th} shapelet and the first segment for State 1 1011 of the corresponding flight.

Further, column 1022 of submatrix 1016 comprises a distance for a shapelet-segment pairing between a first shapelet and the second segment for State S 1012 of the corresponding flight. Column 1024 of submatrix 1016 comprises a distance for a shapelet-segment pairing between a 1k^{th} shapelet and the second segment for State S 1012 of the corresponding flight.

In FIGS. 8-10, a two-tiered feature extraction process may be employed, which calculates moving aggregates of distances in time windows. These time windows may be, for example, over 15 flights, 20 flights, 40 flights, some other number of flights, or some other time window. Aggregates of distances may include average, standard deviation, slope, the difference between maximum and minimum, or some other type of measurement parameter. In this process, the original distances may be replaced by the moving aggregates. These moving aggregates may be added to the corresponding prognostic distance matrix as additional columns, while maintaining the general structure of the prognostic distance matrix.

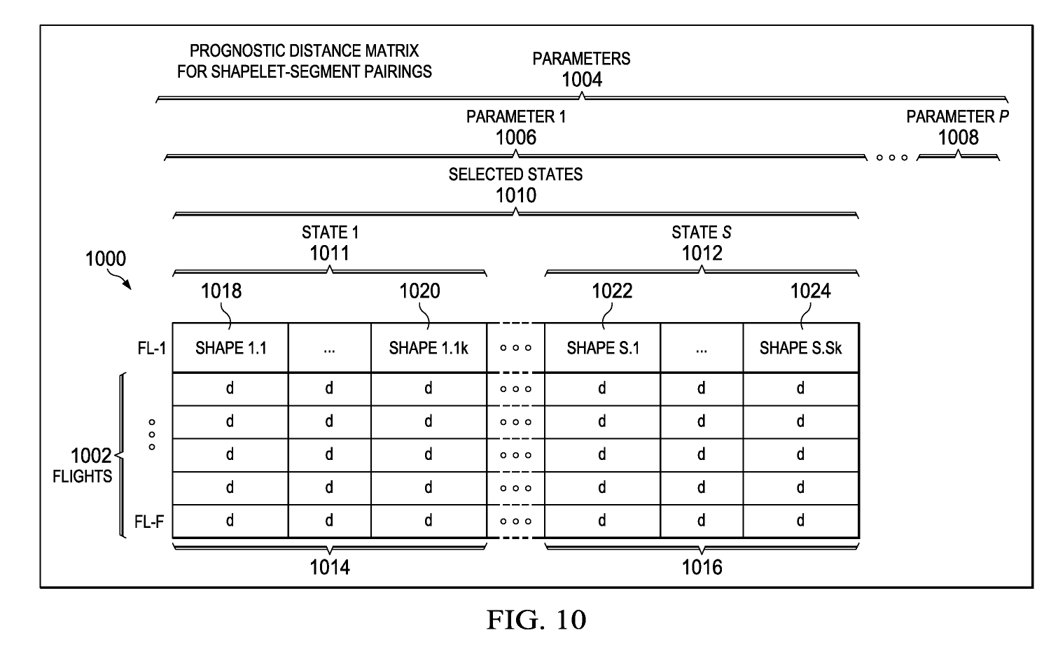

With reference now to FIG. 11, an illustration of a ranking of distances is depicted in accordance with an illustrative embodiment. In this illustrative example, graph 1100 of distance types 1101 is depicted in accordance with an illustrative embodiment. Graph 1100 is a bar graph in which each bar represents the importance of a distance for predicting a problem in a component of an aircraft, such as aircraft 100 in FIG. 1.

In this illustrative example, graph 1100 ranks the variable importance of the different types of distances that may be computed for segment-segment pairings that capture temperature measurements for two complementary brake systems in an aircraft. For example, the different distance types 1101 that may be computed for a pair of segments may include, but are not limited to, distances computed using algorithms currently available in the time series data mining field, distances custom-designed for the intended application, or both.

The distance types 1101 in graph 1100 are ranked according to variable importance 1102. In one illustrative example, the importance of a particular distance type may be a weighting to be used when a distance of that distance type is input into a machine learning algorithm. These weightings may be changed to change the overall importance of the different distance types 1101 in generating a final score or prognostic indicator for the brake system. This final score may also be referred to as an anomaly score.

For example, all of distance types 1101 shown may be computed for a pair of segmented time series. These distances may be put into a matrix form and input into a machine learning algorithm that generates a final score. This final score may be a prognostic indicator with respect to the health of the brake system.

In some illustrative examples, an algorithm may be used to select which distance types are more important than others. For example, without limitation, the Boruta algorithm may be used to select the relevant distances.

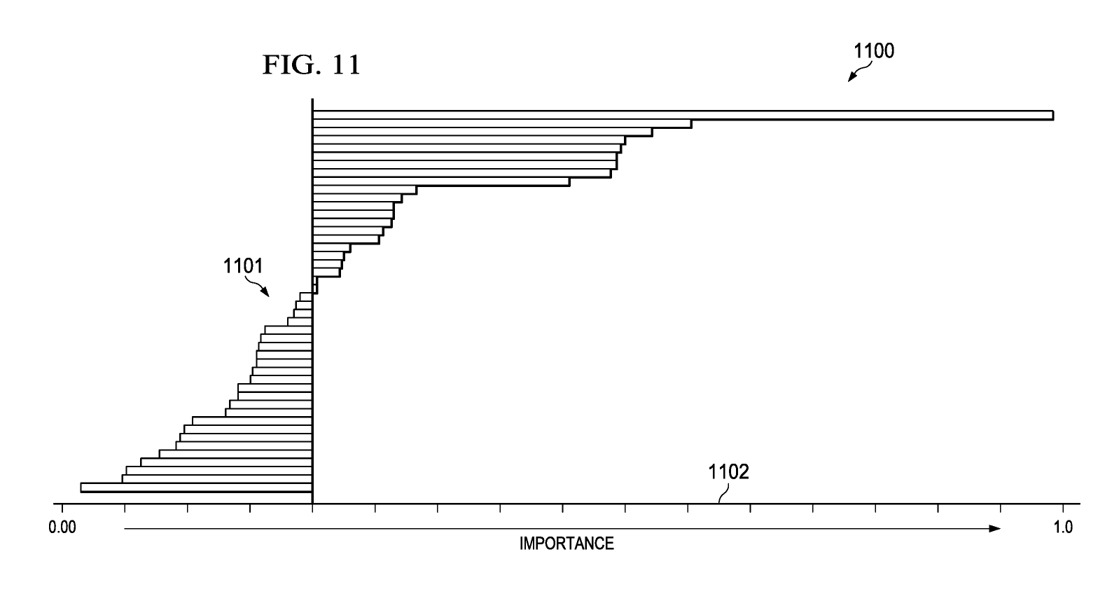

With reference now to FIG. 12, an illustration of digital prognoses is depicted in accordance with an illustrative embodiment. In this illustrative example, digital prognosis 1200 may be an example of one implementation for digital prognosis 235 in FIG. 2. Digital prognosis 1200 is depicted with respect to flight date axis 1202. Digital prognosis 1200 includes component plot 1204, component plot 1206, component plot 1208, and component plot 1210. Each of component plot 1204, component plot 1206, component plot 1208, and component plot 1210 corresponds to a different component of an aircraft and is a plot of graphical indicators.

As depicted, digital prognosis 1200 includes multiples plots that include graphical indicators 1212. Each of graphical indicators 1212 in digital prognosis 1200 represents a prognostic indicator that was generated by a machine learning algorithm, such as from a set of machine learning algorithms 230 in FIG. 2. Digital prognosis 1200 also identifies events 1213 that are of interest.

Graphical indicators 1212 include healthy indicators 1214, mild alert indicators 1216, and severe alert indicators 1218. Each of these indicators represents the health status of the corresponding component on a particular flight date, as determined by the health manager, which may be, for example, health manager 208 in FIG. 3. For example, the health manager may generate prognostic indicators for the components based on distances computed based on segments. These prognostic indicators are visually represented by graphical indicators 1212.

Each of healthy indicators 1214 indicates that the performance of the corresponding component on the corresponding flight date was within selected tolerances of nominal performance. Each of mild alert indicators 1216 indicates that the performance of the corresponding component on the corresponding flight date deviated from nominal performance sufficiently to warrant a mild alert. Each of severe alert indicators 1218 indicates that the performance of the corresponding component on the corresponding flight date deviated from nominal performance sufficiently to warrant a severe alert.

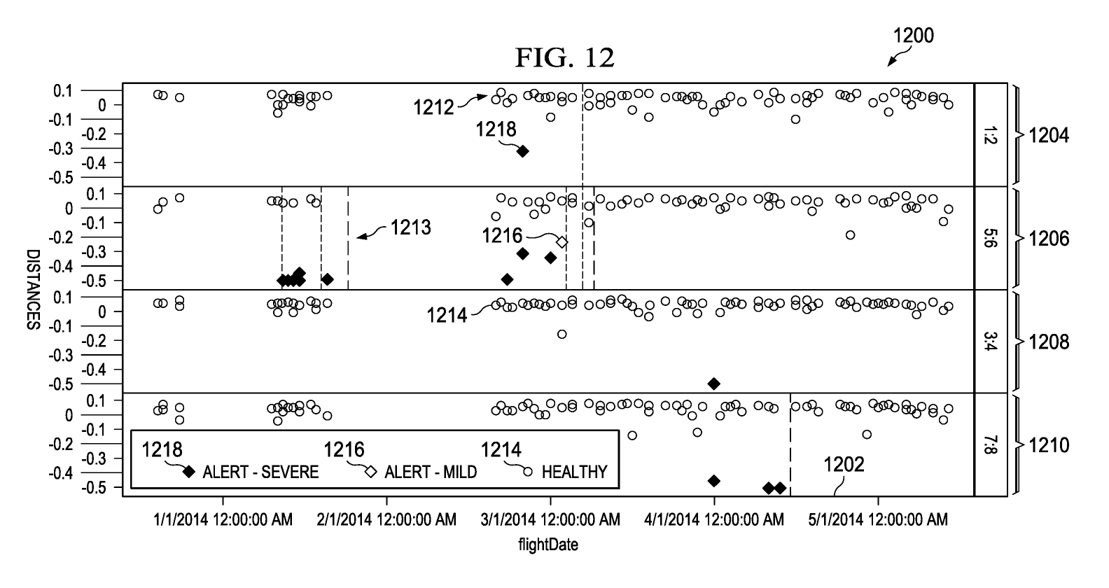

With reference now to FIG. 13, an illustration of a process for evaluating a component of a vehicle is depicted in the form of a flowchart in accordance with an illustrative embodiment. The process illustrated in FIG. 13 may be implemented using health management system 200 in FIG. 2.

The process may begin by receiving time series data generated during operation of a vehicle (operation 1300). Next, the time series data is transformed into a plurality of segments based on a selected state for the vehicle that is of interest (operation 1302).

Thereafter, a prognostic distance matrix is built based on pairings formed using the plurality of segments in which the prognostic distance matrix comprises distances that measure deviation of the component from nominal performance for the selected state (operation 1304). A digital prognosis is generated for the component of the vehicle based on the prognostic distance matrix in which the digital prognosis predicts whether a maintenance operation should be performed with respect to the component (operation 1306), with the process terminating thereafter.

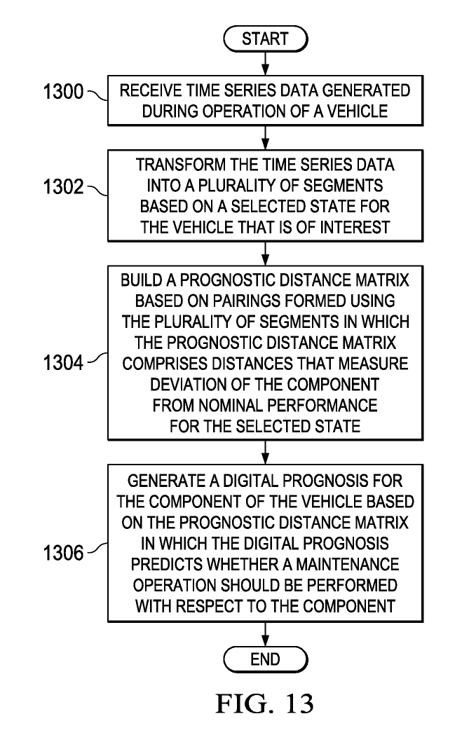

With reference now to FIG. 14, an illustration of a process for evaluating a component of an aircraft is depicted in the form of a flowchart in accordance with an illustrative embodiment. The process illustrated in FIG. 13 may be implemented using health management system 200 in FIG. 2.

The process may begin by receiving time series data in which each time series in the time series data measures at least one performance parameter for a component of an aircraft (operation 1400). Next, the time series data is transformed into a plurality of segments (operation 1402). A plurality of pairings are formed using the plurality of segments in which the plurality of pairings include at least one of segment-segment pairings, segment-nominal pairings, or shapelet-segment pairings (operation 1404).

Next, at least one distance is computed for each pairing in the plurality of pairings (operation 1406). In operation 1406, different distances of different distance types may be computed for a same pairing.

Thereafter, the computed distances may be used in a number of different ways. For example, without limitation, the distances may be used to perform at least one of operation 1408, operation 1410, or operation 1410 described below.

In one illustrative example, the distances may be used to aid in visualizing at least one time series in the time series data (operation 1408), with the process terminating thereafter. In some cases, operation 1408 may be performed by displaying a visual representation of a time series in a graphical user interface on a display system. Further, a number of distance features may be displayed in a separate plot that allows marking extreme distances while seeing the associated time series.

Further, in some cases, in operation 1408, a number of event features may be displayed in association with the visual representation to identify the correlation between events and the distances. The visual presentation of the times of events and the distance features may help a user understand when extreme distances precede an identified event. If so, these distances may be useful prognostic features.

In another illustrative example, after the distances are computed in operation 1406, the distances may be used to build a prognostic distance matrix that is input into a set of machine learning algorithms for use in generating a number of prognostic indicators with respect to the health of the component (operation 1410), with the process terminating thereafter. In some illustrative examples, once the distances are computed in operation 1406, the distances may be used to help diagnose an undesired inconsistency in the performance of the component (operation 1412), with the process terminating thereafter.

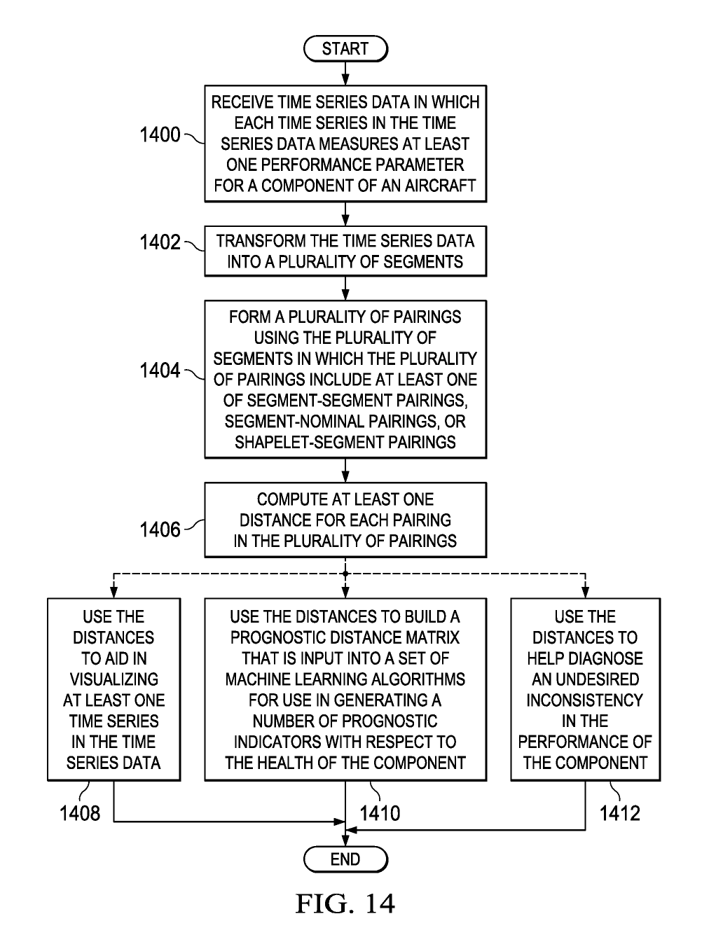

With reference now to FIG. 15, an illustration of a process for computing a distance is depicted in the form of a flowchart in accordance with an illustrative embodiment. The process illustrated in FIG. 15 may be implemented using distance generator 206 in FIG. 2.

The process may begin by selecting a pairing for processing (operation 1500). A determination is made as to whether the pairing is a segment-segment pairing built between a first segment extracted from a portion of the time series data generated by a first sensor during the selected state and a second segment extracted from another portion of the time series data generated by a second sensor during the selected state (operation 1502).

If the pairing is a segment-segment pairing, a distance is computed between the first segment and the second segment of the segment-segment pairing (operation 1504), with the process terminating thereafter. Otherwise, if the pairing is not a segment-segment pairing, a determination is made as to whether the pairing is a segment-nominal pairing built between a segment extracted from a portion of the time series data generated during a selected state and a nominal segment (operation 1506).

In some cases, the nominal segment may comprise expected values obtained through, for example, without limitation, subject matter expertise, engineering tables, or some other source. In other cases, the nominal segment may comprise values that have been estimated based on historical data. In yet other illustrative example, a nominal segment may be a segment from time series data for a same selected state that was previously identified as representing nominal performance. In this manner, the nominal segment may have been identified in a number of different ways including, but not limited to, training or previous analysis.

If the pairing is a segment-nominal pairing, a distance is computed between the actual values of the segment and the expected values of the nominal segment (operation 1508), with the process terminating thereafter. Otherwise, a determination is made as to whether the pairing is a shapelet-segment pairing in which the shapelet is a subsequence that is present in either non-nominal performance or nominal performance but not both (operation 1510).

If the pairing is a shapelet-segment pairing, the distance is computed by identifying a best match between the shapelet and one of a plurality of sections of the segment (operation 1512), with the process terminating thereafter. Otherwise, the process terminates.

The shapelet may be a subsequence within a selected segment that has been identified as representative of nominal performance or non-nominal performance but not both. For example, prior segments that have been identified as representing an unhealthy condition may be searched to find a local section that is representative of non-nominal performance. In some cases, multiple local sections from training may be processed and used to create a shapelet.

In operation 1512, the shapelet may be slid over different sections of the segment, which may or may not overlap. A distance may be computed for each pairing of the shapelet and a section of the segment. The smallest distance may be used as the best match in operation 1512.

The flowcharts and block diagrams in the different depicted embodiments illustrate the architecture, functionality, and operation of some possible implementations of apparatus and methods in an illustrative embodiment. In this regard, each block in the flowcharts or block diagrams may represent a module, a segment, a function, and/or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram.

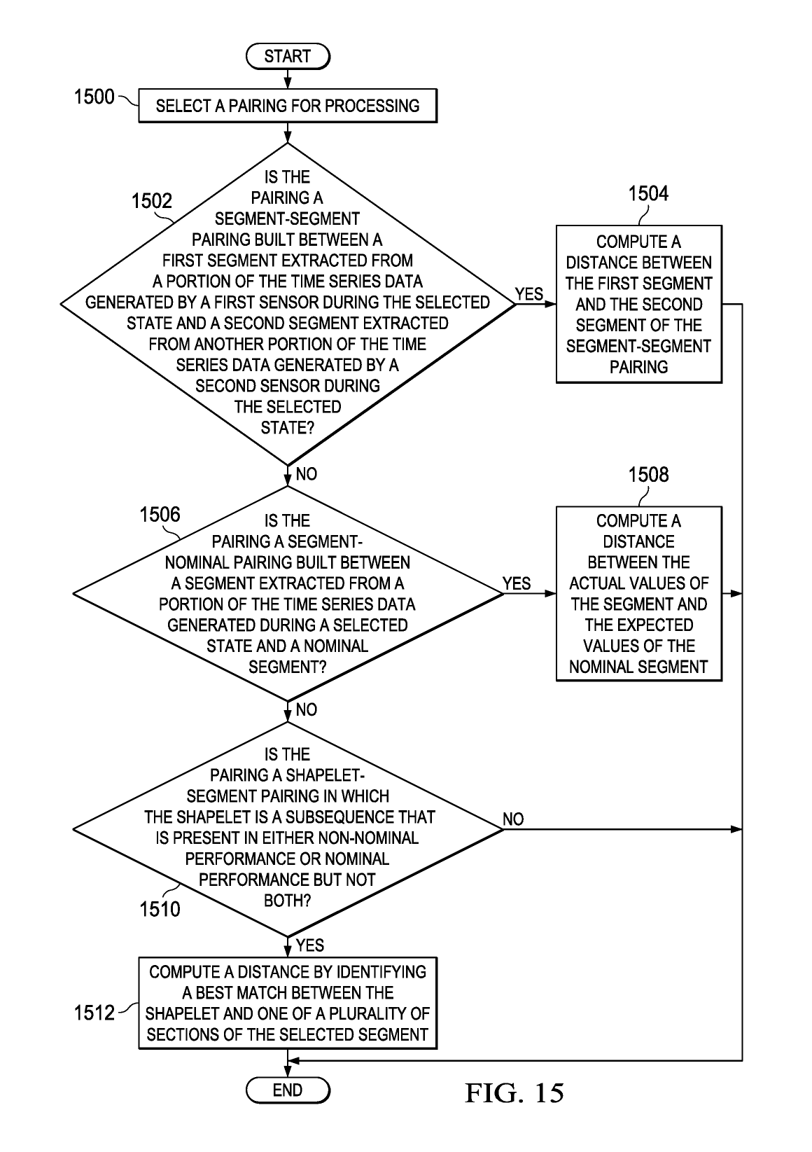

Turning now to FIG. 16, an illustration of a data processing system in the form of a block diagram is depicted in accordance with an illustrative embodiment. Data processing system 1600 may be used to implement computer system 203 in FIG. 2. As depicted, data processing system 1600 includes communications framework 1602, which provides communications between processor unit 1604, storage devices 1606, communications unit 1608, input/output unit 1610, and display 1612. In some cases, communications framework 1602 may be implemented as a bus system.

Processor unit 1604 is configured to execute instructions for software to perform a number of operations. Processor unit 1604 may comprise a number of processors, a multi-processor core, and/or some other type of processor, depending on the implementation. In some cases, processor unit 1604 may take the form of a hardware unit, such as a circuit system, an application specific integrated circuit (ASIC), a programmable logic device, or some other suitable type of hardware unit.

Instructions for the operating system, applications, and/or programs run by processor unit 1604 may be located in storage devices 1606. Storage devices 1606 may be in communication with processor unit 1604 through communications framework 1602. As used herein, a storage device, also referred to as a computer readable storage device, is any piece of hardware capable of storing information on a temporary and/or permanent basis. This information may include, but is not limited to, data, program code, and/or other information.

Memory 1614 and persistent storage 1616 are examples of storage devices 1606. Memory 1614 may take the form of, for example, a random access memory or some type of volatile or non-volatile storage device. Persistent storage 1616 may comprise any number of components or devices. For example, persistent storage 1616 may comprise a hard drive, a flash memory, a rewritable optical disk, a rewritable magnetic tape, or some combination of the above. The media used by persistent storage 1616 may or may not be removable.

Communications unit 1608 allows data processing system 1600 to communicate with other data processing systems and/or devices. Communications unit 1608 may provide communications using physical and/or wireless communications links.

Input/output unit 1610 allows input to be received from and output to be sent to other devices connected to data processing system 1600. For example, input/output unit 1610 may allow user input to be received through a keyboard, a mouse, and/or some other type of input device. As another example, input/output unit 1610 may allow output to be sent to a printer connected to data processing system 1600.

Display 1612 is configured to display information to a user. Display 1612 may comprise, for example, without limitation, a monitor, a touch screen, a laser display, a holographic display, a virtual display device, and/or some other type of display device.

In this illustrative example, the processes of the different illustrative embodiments may be performed by processor unit 1604 using computer-implemented instructions. These instructions may be referred to as program code, computer usable program code, or computer readable program code and may be read and executed by one or more processors in processor unit 1604.

In these examples, program code 1618 is located in a functional form on computer readable media 1620, which is selectively removable, and may be loaded onto or transferred to data processing system 1600 for execution by processor unit 1604. Program code 1618 and computer readable media 1620 together form computer program product 1622. In this illustrative example, computer readable media 1620 may be computer readable storage media 1624 or computer readable signal media 1626.

Computer readable storage media 1624 is a physical or tangible storage device used to store program code 1618 rather than a medium that propagates or transmits program code 1618. Computer readable storage media 1624 may be, for example, without limitation, an optical or magnetic disk or a persistent storage device that is connected to data processing system 1600.

Alternatively, program code 1618 may be transferred to data processing system 1600 using computer readable signal media 1626. Computer readable signal media 1626 may be, for example, a propagated data signal containing program code 1618. This data signal may be an electromagnetic signal, an optical signal, and/or some other type of signal that can be transmitted over physical and/or wireless communications links.

The illustration of data processing system 1600 in FIG. 16 is not meant to provide architectural limitations to the manner in which the illustrative embodiments may be implemented. The different illustrative embodiments may be implemented in a data processing system that includes components in addition to or in place of those illustrated for data processing system 1600. Further, components shown in FIG. 16 may be varied from the illustrative examples shown.

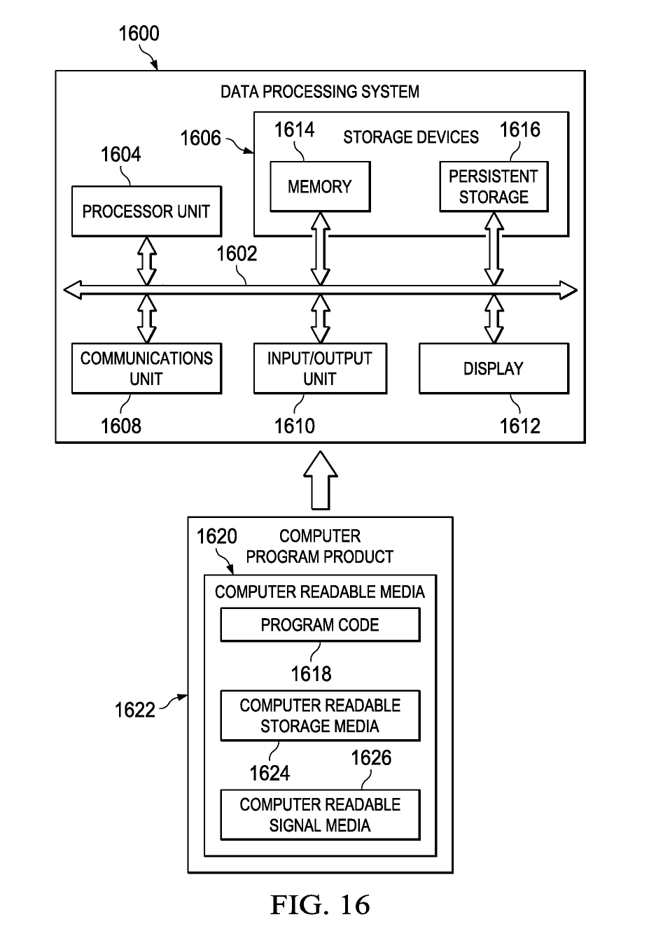

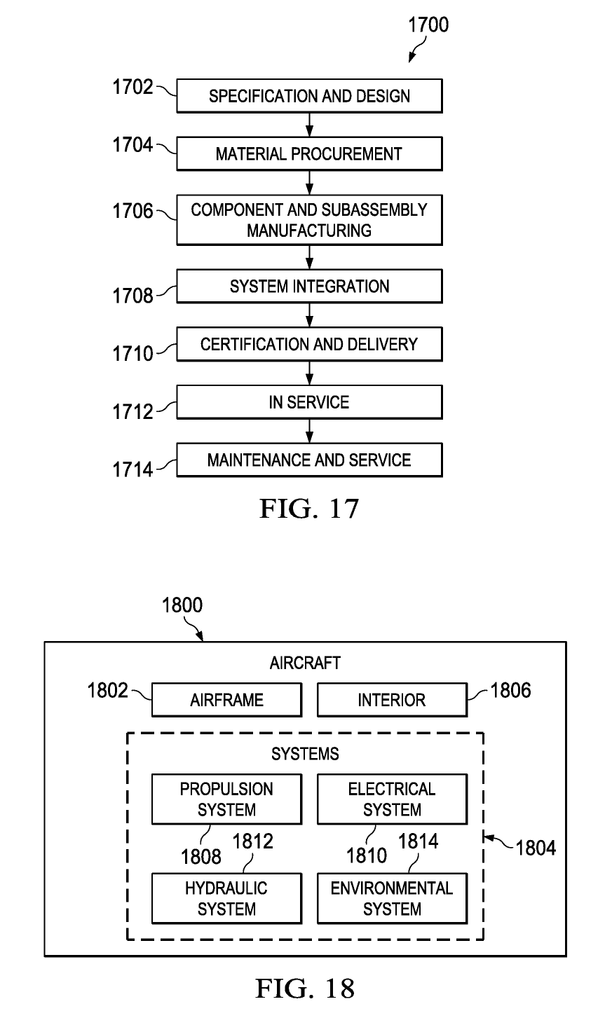

Illustrative embodiments of the disclosure may be described in the context of aircraft manufacturing and service method 1700 as shown in FIG. 17 and aircraft 1800 as shown in FIG. 18. Turning first to FIG. 17, an illustration of an aircraft manufacturing and service method is depicted in accordance with an illustrative embodiment. During pre-production, aircraft manufacturing and service method 1700 may include specification and design 1702 of aircraft 1800 in FIG. 18 and material procurement 1704.

During production, component and subassembly manufacturing 1706 and system integration 1708 of aircraft 1800 in FIG. 18 takes place. Thereafter, aircraft 1800 in FIG. 18 may go through certification and delivery 1710 in order to be placed in service 1712. While in service 1712 by a customer, aircraft 1800 in FIG. 18 is scheduled for routine maintenance and service 1714, which may include modification, reconfiguration, refurbishment, and other maintenance or service.

Each of the processes of aircraft manufacturing and service method 1700 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 18, an illustration of an aircraft is depicted in which an illustrative embodiment may be implemented. In this example, aircraft 1800 is produced by aircraft manufacturing and service method 1700 in FIG. 17 and may include airframe 1802 with plurality of systems 1804 and interior 1806. Examples of systems 1804 include one or more of propulsion system 1808, electrical system 1810, hydraulic system 1812, and environmental system 1814. Any number of other systems may be included. Although an aerospace example is shown, different illustrative embodiments may be applied to other industries, such as the automotive industry.

Apparatuses and methods embodied herein may be employed during at least one of the stages of aircraft manufacturing and service method 1700 in FIG. 17. In particular, health management system 200 from FIG. 2 may be used to evaluate the health of aircraft 1800 during any one of the stages of aircraft manufacturing and service method 1700. For example, without limitation, health management system 200 from FIG. 2 may be used to evaluate the health of aircraft during at least one of system integration 1708, certification and delivery 1710, in service 1712, routine maintenance and service 1714, or some other stage of aircraft manufacturing and service method 1700. Still further, health management system 200 from FIG. 2 may be used to evaluate the health of aircraft 1800 and systems 1804 that make up aircraft 1800 over the life of the aircraft.

In one illustrative example, components or subassemblies produced in component and subassembly manufacturing 1706 in FIG. 17 may be fabricated or manufactured in a manner similar to components or subassemblies produced while aircraft 1800 is in service 1712 in FIG. 17. As yet another example, one or more apparatus embodiments, method embodiments, or a combination thereof may be utilized during production stages, such as component and subassembly manufacturing 1706 and system integration 1708 in FIG. 17. One or more apparatus embodiments, method embodiments, or a combination thereof may be utilized while aircraft 1800 is in service 1712 and/or during maintenance and service 1714 in FIG. 17. The use of a number of the different illustrative embodiments may substantially expedite the assembly of and/or reduce the cost of aircraft 1800.

Thus, the illustrative embodiments provide a method and apparatus for evaluating the health of a system, such as an aircraft, using segmented time series and distances. Multiple time series of sensor measurements may be represented as distances that measure deviation from healthy behavior. A matrix of distances may then be fed as input into downstream prognostic machine learning algorithms.

The illustrative embodiments provide a process of segment selection and distance extraction and selection. Further, these distances may be used to select individual time series worthy of closer examination, graphically represent trends leading up to an undesired event, and diagnose the cause of undesired inconsistencies.

By segmenting multiple time series, these time series may be restructured to reduce overall data volume without sacrificing information. Further, using distances computed based on segmented time series helps better represent the information in the data to match analysis goals of machine learning algorithms. These distances may better help identify which components or sensor streams deviate from nominal performance sufficiently to warrant extra attention. Patterns associated with large deviations from nominal performance may also help provide insight into the reasons behind these deviations.

The illustrative embodiments provide a method and apparatus that enable calculating a basket of distances on a set of performance parameters for a complex system even when the durations of interest are not of the same length and when the sampling rates vary. These distances may be used predicting and diagnosing problems with a desired level of accuracy.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for evaluating a component of a vehicle, the method comprising:
receiving, by a computer system, time series data generated during operation of the vehicle;
transforming, by the computer system, the time series data into a plurality of segments based on a selected state for the vehicle that is of interest;
building, by the computer system, a prognostic distance matrix based on pairings formed using the plurality of segments,
wherein the prognostic distance matrix comprises distances that measure deviation of the component from nominal performance for the selected state; and
generating, by the computer system, a digital prognosis for the component of the vehicle based on the prognostic distance matrix, wherein the digital prognosis predicts whether a maintenance operation should be performed with respect to the component.

2. The method of claim 1 further comprising:
generating, by the computer system, a diagnosis output based on at least a portion of the distances in the prognostic distance matrix, wherein the diagnosis output helps a user determine what maintenance operation should be performed.

3. The method of claim 1 further comprising:
performing the maintenance operation for the component of the vehicle, wherein the maintenance operation comprises at least one of inspection, preventative maintenance, corrective maintenance, adaptive maintenance, in-use maintenance, repair, rework replacement, or overhaul.

4. The method of claim 1, wherein transforming, by the computer system, the plurality of segments into the prognostic distance matrix comprises:
building a plurality of pairings using the plurality of segments; and
computing a distance for each pairing of the plurality of pairings.

5. The method of claim 4, wherein building the plurality of pairings comprises:
building a segment-segment pairing between a first segment extracted from a portion of the time series data generated by a first sensor during the selected state and a second segment extracted from another portion of the time series data generated by a second sensor during the selected state.

6. The method of claim 4, wherein building the plurality of pairings comprises:
identifying a nominal segment for the selected state; and
building a segment-nominal pairing between a segment extracted from a portion of the time series data generated during the selected state and a nominal segment.

7. The method of claim 6, wherein identifying the nominal segment comprises:
estimating expected values for the selected state to form the nominal segment.

8. The method of claim 4, wherein building the plurality of pairings comprises:
identifying a shapelet for use in analyzing a segment of the plurality of segments, wherein the shapelet is a subsequence that is present in either non-nominal performance or nominal performance but not both; and
building a shapelet-segment pairing between the segment and the shapelet.

9. The method of claim 8, wherein computing the distance comprises:
computing the distance for the shapelet-segment pairing by identifying a best match between the shapelet and one of a plurality of sections of the segment.

10. The method of claim 1, wherein building, by the computer system, the prognostic distance matrix comprises:
building the prognostic distance matrix for segment-segment pairings, wherein the distances included in the prognostic distance matrix are computed for each distance type of a number of different distance types and wherein the distances for the each distance type are computed for each selected state of a number of selected states.

11. The method of claim 1, wherein building, by the computer system, the prognostic distance matrix comprises:
building the prognostic distance matrix for segment-nominal pairings, wherein the distances included in the prognostic distance matrix are computed for a number of different parameters for each selected state in a number of selected states.

12. The method of claim 1, wherein building, by the computer system, the prognostic distance matrix comprises:
building the prognostic distance matrix for segment-nominal pairings, wherein the distances included in the prognostic distance matrix are computed for a number of different types of shapelets for each selected state of a number of selected states and wherein the distances computed for the number of selected states are computed for each parameter of a number of different parameters.

13. The method of claim 1, wherein generating, by the computer system, the digital prognosis comprises:
analyzing, by a set of machine learning algorithms, the prognostic distance matrix; and
generating a number of prognostic indicators based on the prognostic distance matrix that are included in the digital prognosis.

14. The method of claim 1, wherein generating, by the computer system, the digital prognosis comprises:
analyzing, by a set of machine learning algorithms, the prognostic distance matrix; and
generating a final score for the component based on the prognostic distance matrix that is used to classify the component as either healthy or not healthy.

15. The method of claim 1 further comprising:
displaying the digital prognosis in a graphical user interface on a display system, wherein the digital prognosis includes a plot of graphical indicators and wherein each of the graphical indicators represents a prognostic indicator with respect to a health of the component.

16. The method of claim 1, wherein transforming, by the computer system, the time series data into the plurality of segments comprises:
identifying each portion of data in the time series data that includes measurements generated during the selected state; and
forming at least one segment using each portion of the data.

17. The method of claim 1 further comprising:
selecting the selected state for the vehicle that is of interest, wherein the vehicle is an aircraft and wherein the selected state is selected from one of an entire flight of the aircraft, a particular phase of flight, a selected portion of a flight, a selected time period during flight, or a selected time period after a number of commands are sent from an aircraft control system to the component.

18. The method of claim 1 further comprising:
displaying a visual representation of the time series data in a graphical user interface on a display system; and
displaying a number of distance features in association with the visual representation of the time series data that correspond to extreme distances.

19. An apparatus comprising:
a segment generator module implemented in a computer system that receives time series data generated during operation of a vehicle and transforms the time series data into a plurality of segments based on a selected state for the vehicle that is of interest;
a distance generator module implemented in the computer system that builds a prognostic distance matrix based on pairings formed using the plurality of segments,
wherein the prognostic distance matrix comprises distances that measure deviation of a component from nominal performance for the selected state; and
a health manager module implemented in the computer system that generates a digital prognosis for the component of the vehicle based on the prognostic distance matrix, wherein the digital prognosis predicts whether a maintenance operation should be performed with respect to the component and wherein the distances are used to diagnose what maintenance operation should be performed.

20. The apparatus of claim 19, wherein the health manager module generates a diagnosis output based on at least a portion of the distances in the prognostic distance matrix, wherein the diagnosis output helps a user determine what maintenance operation should be performed.

21. The apparatus of claim 19, wherein the vehicle is an aircraft and wherein the selected state is selected from one of an entire flight of the aircraft, a particular phase of flight, a selected portion of a flight, a selected time period during flight, or a selected time period after a number of commands are sent from an aircraft control system to the component.

22. The apparatus of claim 19, wherein a distance in the prognostic distance matrix is for one of a segment-segment pairing, a shapelet-segment pairing, and a segment-nominal pairing.

23. The apparatus of claim 19, wherein the maintenance operation comprises at least one of inspection, preventative maintenance, corrective maintenance, adaptive maintenance, in-use maintenance, repair, rework replacement, or overhaul.

24. The apparatus of claim 19, wherein the digital prognosis is displayed in a graphical user interface using plot of graphical indicators and wherein each graphical indicator represents a prognostic indicator with respect to health of the component.

25. A health management system comprising:
a segment generator module implemented in a computer system that receives time series data generated during operation of an aircraft and transforms the time series data into a plurality of segments based on a selected state for the aircraft that is of interest;
a distance generator module implemented in the computer system that builds a prognostic distance matrix based on pairings formed using the plurality of segments,
wherein the prognostic distance matrix comprises distances that measure deviation of a component from nominal performance for the selected state; and
a health manager module implemented in the computer system that generates a digital prognosis for the component of the aircraft based on the prognostic distance matrix, wherein the digital prognosis predicts whether a maintenance operation should be performed with respect to the component and wherein the distances are used to diagnose what maintenance operation should be performed.
